(19) United States
(12) Patent Application Publication
(10) Pub. No.: US 2025/0317708 A1
(43) Pub. Date: Oct. 9, 2025

(54) DYNAMIC UPLINK OPTIMIZATION PROCEDURES FOR POSITIONING OF INACTIVE DEVICES

(71) Applicant: Nokia Technologies Oy, Espoo (FI)

(72) Inventors: Oana-Elena BARBU, Aalborg (DK); Diomidis MICHALOPOULOS, Munich (DE)

(21) Appl. No.: 18/866,841

(22) PCT Filed: Jun. 5, 2023
(86) PCT No.: PCT/IB2023/055779

§ 371 Date: Nov. 18, 2024

Related U.S. Application Data
(60) Provisional application No. 63/350,201, filed on Jun. 8, 2022.

(51) Int. Cl. H04W 4/02; H04L 5/00

(52) U.S. Cl. CPC H04W 4/025; H04L 5/0044; H04L 5/0053

(57) ABSTRACT

Systems, methods, apparatuses, and computer program TRP products for dynamic uplink optimization procedures for positioning of inactive devices, such as reduced capability devices and other user equipment are provided. For example, a method can include transmitting to a user equipment a positioning-specific association between a sounding reference signal index and an index of downlink resources. Also, the method can include configuring the user equipment with a reporting behavior for uplink positioning in radio resource control inactive mode. Receiving a parameter from the user equipment according to the configured reporting behavior can also be included in the method.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for providing dynamic uplink optimization procedures for positioning of inactive devices, such as reduced capability devices and other user equipment.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus. The apparatus can include at least one processor and at least one memory including computer program code. The at least one memory and the computer program code can be configured to, with the at least one processor, cause the apparatus at least to perform transmitting to a user equipment a positioning-specific association between a sounding reference signal index and an index of downlink resources. Also, the at least one memory and the computer program code can be configured to, with the at least one processor, cause the apparatus at least to perform configuring the user equipment with a reporting behavior for uplink positioning in radio resource control inactive mode. The at least one memory and the computer program code can further be configured to, with the at least one processor, cause the apparatus at least to perform receiving a parameter from the user equipment according to the configured reporting behavior. (To be completed once claims are reviewed.)

An embodiment may be directed to an apparatus. The apparatus can include at least one processor and at least one memory including computer program code. The at least one memory and the computer program code can be configured to, with the at least one processor, cause the apparatus at least to perform receiving a positioning-specific association between a sounding reference signal index and an index of downlink resources. Also, the at least one memory and the computer program code can be configured to, with the at least one processor, cause the apparatus at least to perform receiving a configuration of a reporting behavior for uplink positioning in radio resource control inactive mode. The at least one memory and the computer program code can further be configured to, with the at least one processor, cause the apparatus at least to perform transmitting a parameter according to the configured reporting behavior.

An embodiment may be directed to a method. The method can include transmitting to a user equipment a positioning-specific association between a sounding reference signal index and an index of downlink resources. Also, the method can include configuring the user equipment with a reporting behavior for uplink positioning in radio resource control inactive mode. Receiving a parameter from the user equipment according to the configured reporting behavior can also be included in the method.

An embodiment may be directed to a method. The method can include receiving, by a user equipment, a positioning-specific association between a sounding reference signal index and an index of downlink resources. Also, the method can include receiving, by the user equipment, a configuration of a reporting behavior for uplink positioning in radio resource control inactive mode. Transmitting, by the user equipment, a parameter according to the configured reporting behavior can be included in the method.

An embodiment may be directed to an apparatus. The apparatus can include means for transmitting to a user equipment a positioning-specific association between a sounding reference signal index and an index of downlink resources. Also, the apparatus can include means for configuring the user equipment with a reporting behavior for uplink positioning in radio resource control inactive mode. Means for receiving a parameter from the user equipment according to the configured reporting behavior can also be included.

An embodiment may be directed to an apparatus. The apparatus can include means for receiving a positioning-specific association between a sounding reference signal index and an index of downlink resources. Also, the apparatus can include means for receiving a configuration of a reporting behavior for uplink positioning in radio resource control inactive mode. Means for transmitting a parameter according to the configured reporting behavior can be include as well.

### BRIEF DESCRIPTION OF THE DRAWINGS

For proper understanding of example embodiments, reference should be made to the accompanying drawings, wherein:

FIG. 1 illustrates a flow-chart of a method according to certain embodiments;

FIG. 2 illustrates a further flow-chart of a method according to certain embodiments;

FIG. 3 illustrates a signal flow of an embodiment corresponding to an example implementation of FIG. 1; and

FIG. 4 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing dynamic uplink optimization procedures for positioning of inactive devices, such as reduced capability devices and other user equipment, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain embodiments relate to new radio (NR) positioning. More particularly, certain embodiments relate to uplink (UL) positioning procedures for low power user equipment (UEs) such as release 18 (Rel-18) NR reduced capability (RedCap) devices. These devices may extend the radio resource control (RRC) inactive state as much as possible, thereby saving energy. NR-based radio access technology (RAT) dependent positioning solutions may enable localization in both frequency range one (FR1) and frequency range two (FR2). The RAT dependent positioning solutions can be divided into downlink (DL), UL, and DL/UL positioning technologies.

NR has three RRC states including RRC connected, RRC idle and RRC inactive state, in the example implementation described in third generation partnership project (3GPP) technical report (TR) 38.804. In such an implementation, when a UE is in RRC connected state, the UE can communicate with the next generation Node B (gNB) using the typical NR physical channels and procedures. If there is no data transmission between the gNB and the UE, the UE may switch to the RRC idle or RRC inactive state to reduce power consumption. UE in RRC inactive state can move to RRC connected or RRC idle, but UE in RRC idle cannot move to RRC inactive in such implementations. In general, UE in RRC idle or RRC inactive may return to RRC connected state to use typical NR physical channels and procedures for data transmission between gNB and UE. A UE in RRC inactive is allowed to transmit small UL data (SDT) without necessarily performing a full state transition to RRC connected with the 4-step or 2-step RACH procedure, according to the example implementations described in 3GPP TR 38.804.

Given the allowance for SDT traffic in RRC inactive, UL positioning may be possible for an inactive NR UE. Specifically, SDT messages may be used to request and report positioning information, but also to (re)configure an inactive positioning session. Further to that, the location management function (LMF) may be able to respond upon receiving UE SDT message containing positioning information.

For example, an uplink location services (LCS) or long term evolution (LTE) positioning protocol (LPP) message can be transported in RRC inactive. If a UE-initiated data transmission uses UL SDT, the network can send DL LCS, LPP message and RRC message, for example to configure sounding reference signal (SRS), if UL positioning supported, to the UE. Otherwise, if the UE did not initiate UL SDT, the network can transition the UE to RRC connected, using, for example, radio access network (RAN) paging.

The SRS configuration of a UE in RRC inactive state can be supported for either inside initial bandwidth part (BWP) or outside of initial BWP.

UE mobility may impact UL SDT transmission. For example, a suspension of an RRC connection may be initiated by a serving/anchor base station of a network, such as a gNB. Based on the suspension, the network can store current configuration parameters of a UE in UE contexts. The UE may initiate a resumption of an RRC connection on a target/non-anchor base station different from the serving base station. The UE may transmit a request for the resumption to the target/non-anchor base station. Upon receiving the request, the target/non-anchor base station may send a request for the UE contexts to the serving/anchor base station. Based on the non-anchor relocation, small data can be transmitted to the serving/anchor base station via the target/non-anchor base station. The serving/anchor base station can transmit the small data to a core network entity, such as a user plane function (UPF).

To trigger an UL LPP positioning session, the fifth generation (5G) NR LMF may configure the transmission of uplink reference signals for positioning, such as SRS-for-positioning signals. These uplink reference signals for positioning may be configured in relation to the serving cell of the target UE. Thus, the SRS-for-positioning signals may need to be configured by the serving gNB, upon LMF request. The uplink reference signals for positioning may also need to be configured such that enough transmit receive points (TRPs) hear them. To do that, the LMF may benefit from knowing a coarse UE location for each TRP and choose and inform those TRPs that are likely to be in the range of the UE, namely likely to hear the UE.

For devices in RRC connected mode, the LMF may have perfect knowledge of the serving gNB and a continuous estimate of the UE coarse location. The LMF can therefore efficiently configure the UL positioning session with minimal signaling overhead.

In RRC inactive mode however, the UE can move between cells in a transparent manner to the LMF. Therefore, the LMF may not have an updated coarse UE location. Without such updated information, the selection of TRPs may be suboptimally implemented. One resolution to this issue would be to wake up the UE so that the LMF is subsequently updated if/when the UE transitions to a new cell. Transitioning the UE to RRC connected for positioning purposes only, however, may be deemed power-expensive. The periodic nature of positioning applications may exacerbate the power consumption, which may pose challenges to low power UEs, both in terms of signaling overhead and computational complexity. Therefore, certain embodiments may provide a way for an UL positioning session to be successfully maintained or updated while the UE is in RRC inactive.

One option is to reserve SRS resources across cells for inactive UEs. By doing so, such an approach enables the UE to maintain the same SRS configuration from one cell to the other. The resource reservation for positioning approach can address this issue, but at the cost of spectral inefficiency.

Such positioning resource utilization depends on the number of devices configured for UL positioning. This means that in some cases, SRS resources may be under-utilized, while in some other cases, inactive UEs may need to wait before they can access them, beyond their allowed latency figures. Additionally, resource reservation for positioning penalizes other data traffic types such as ultra-reliable low-latency communication (URLLC) which may have much stricter quality of service (QoS) requirements.

Certain embodiments provide an UL positioning session re-configuration for an RRC inactive UE, which may be a RedCap device. Certain embodiments provide methods and corresponding apparatuses that overcome the shortcomings of other approaches while keeping the signaling overhead to a minimum and without requiring the UE to transition to RRC connected. Such features may be achieved by enabling the inactive UE and LMF to exchange a short message, where a message with a payload of tens of bits may be considered a short message, with which the full reconfiguration of the RRC-inactive UL positioning session is possible. More broadly, the type of short message that may be used may be a message appropriate for sending by SDT as distinct from a short message service (SMS) message. See, for example, Annex G of 3GPP TR 38.804 V14.0.0 (2017-03).

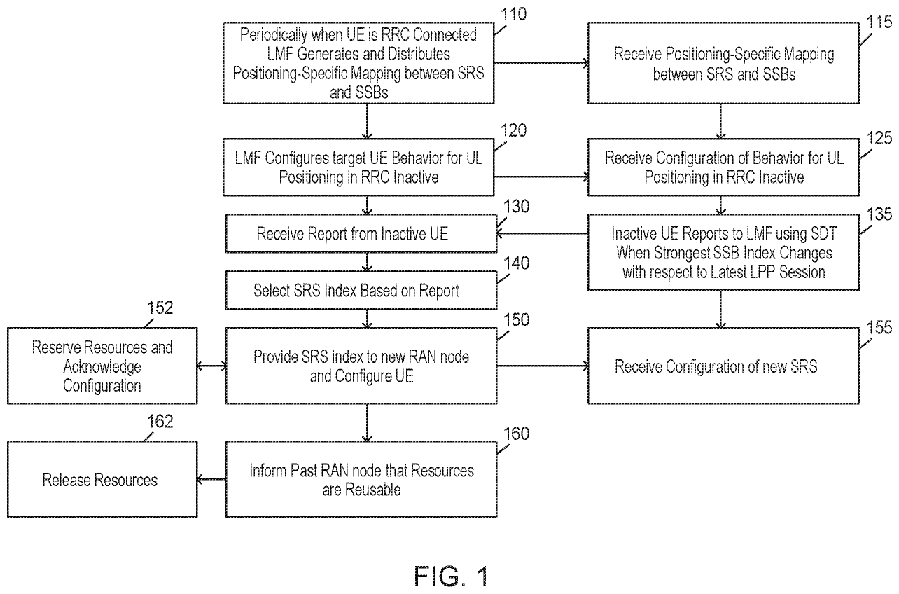

FIG. 1 illustrates a flow-chart of a method according to certain embodiments. As shown in FIG. 1, periodically, when the target UE is RRC connected, the LMF at 110 can generate, transmit, and/or distribute a positioning-specific mapping or association between UL positioning signals, such as SRS, and DL cell-specific references signals (CRSs) and/or UE-specific signals, such as SSBs. The mappings or associations can be sent as long term evolution (LTE) positioning protocol (LPP) and/or new radio positioning protocol A (NRPPa) messages. This may be performed only when the UE is RRC connected, as distinct from RRC inactive.

Such mapping can describe an association between an SSB index and an SRS index, the latter describing a full time-frequency-code SRS configuration. Specifically, the mapping can instruct the UE which SRS configuration to select/use in UL positioning, after the inactive UE has identified the index of the best SSB. The best SSB can be identified in terms of for example, SSBs with relatively greater reference signal received power (RSRP), signal to noise ratio (SNR), and/or the like. SSB is provided as an example of resources, but the mapping could be an association between the index of any suitable resources, such as a symbol or group of symbols, and an SRS index.

For example, in a specific case, the mapping may identify that for best SSB index X, the SRS index may be Set(X)=[x1, x2, . . . ], while for best SSB index Y, the SRS index may be Set(Y)=[y1, y2, . . . ].

SSB monitoring may be performed for other reasons for an RRC-inactive UE, and therefore such use of SSB monitoring for these additional purposes may be done without requiring an inactive UE to perform any additional positioning-related measurements. The UE can receive the positioning-specific mapping at 115.

At 120, the LMF can configure the target UE behavior for UL positioning in RRC inactive using an LPP message. Specifically, the UE can be requested to log the best SSB index for each LPP session. What is best can be defined explicitly by the LMF. For example, the LMF may indicate to use the mapping after the SSB ranking has been performed using one or more of the following key performance indicators (KPIs): SSB-RSRP, SSB-SINR, SSB line of sight (SSB-LOS) indication, and SSB timing advance (SSB-TA).

Thus, for example, the reporting behavior configuration can identify that when a predetermined trigger occurs the user equipment reports, or transmits a report of, a predetermined rank-ordered resource index values and a time stamp of the predetermined trigger. The predetermined trigger can be a determination that a resource index is better than or preferable to a previously best resource index based on criteria provided to or otherwise used by the user equipment. More particularly, the rank-ordered resource index values can include a first predetermined number of values ordered by the criteria provided to or otherwise used by the user equipment. For example, the criteria may be based on at least one of SSB-RSRP, SSB-SINR, SSB-LOS indication, or SSB-TA. Also, or alternatively, the rank-ordered resource index values can include a second predetermined number of sounding reference signal indices, wherein the sounding reference signal indices are derived from the positioning-specific mapping. For example, whenever the strongest SSB index changes with respect to a latest LPP session, then the inactive UE can report to the LMF, using UL SDT transmission, at least the best K>1 SSB indices {X, Y, . . . } and the timestamp when the change occurred. Alternatively or additionally, the target UE may report to the LMF an ordered list L>K of preferred SRS indices, obtained by using the mapping and own SSB quality measurements, e.g. {x1, x2, y1}, which may be provided in an LPP report.

At 125, the configuration can be received by the UE. The UE can then begin operating based on the configuration when the UE enters RRC inactive. At 135, the UE now in inactive mode can report to the LMF using SDT when the predetermined trigger, such as strongest SSB index change, occurs with respect to the latest LPP session. Thus, at 135 the UE can report the indices described above. At 130, the LMF can receive the report from the inactive UE.

At 140, the LMF can select an SRS index based on the parameter provided in the report from the UE. Thus, for example, the LMF can use the K SSB indices and/or the L SRS indices to select an SRS index for example, the LMF can chooses a specific SSB index x2.

Then, at 150, the LMF can provide the SRS index to a new RAN node and can configure the UE. For example, the new radio access network node can be a different radio access network node from a past radio access network node to which the user equipment had been associated. At 152, the new RAN node, which may be a gNB, can reserve resources and acknowledge configuration. At 155, the UE can receive the configuration of the new SRS index that has been selected by the LMF and acknowledged by the new RAN node.

At 160, the LMF can inform the past radio access network node that resources corresponding to the sounding reference signal are reusable by the past radio access network node.

Thus, for example, in one embodiment, which can be described as involving an implicit SRS re-configuration request and agreement, the LMF can provide the SRS index x2 to the new corresponding gNB, which can be identified as gNB X for convenience, using an NRPPa message. The LMF can also inform a past gNB, which can be identified as gNB P for convenience, that the past SRS resources, which can be identified as SRS p for convenience, can be re-purposed. This informing can also be performed in an NRPPa message. The gNB X can reserve the resources associated with SRS x2. The gNB X can also acknowledges the new SRS x2 configuration to the LMF. The LMF can accordingly configure to the UE the new SRS x2, as a response to the UL SDT transmission received above. Then, the LMF can indicate to neighbor gNBs the new SRS x2 configuration in an NRPPa message, and at the same time the UE can switch to SRS x2.

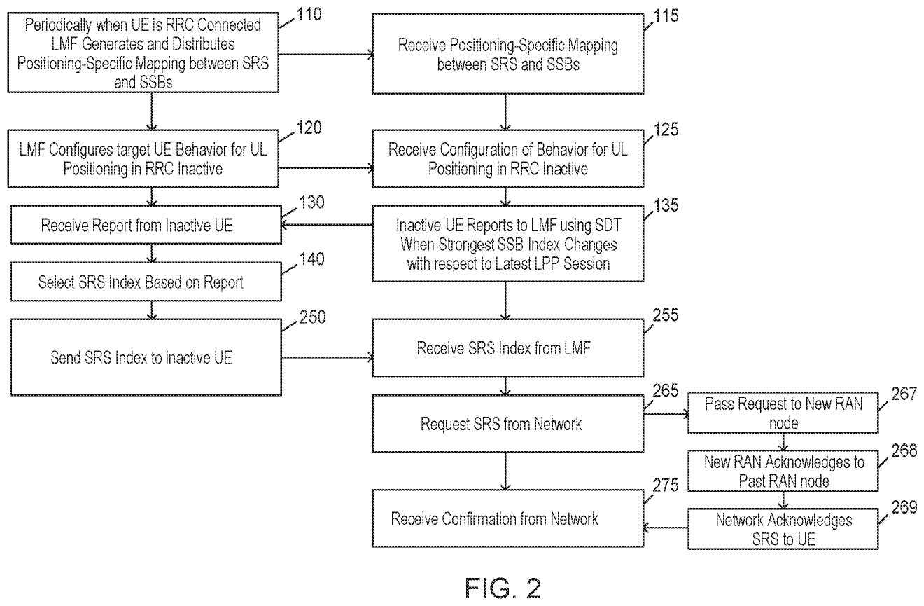

FIG. 2 illustrates a further flow-chart of a method according to certain embodiments. The method of FIG. 2 from 110 to 140 may be as described above with reference to FIG. 1. However, at 250, the LMF can send the SRS index to the UE, which may be inactive. The inactive UE can receive the SRS index at 255 and request the SRS from the network at 265. At 267, a past RAN node can pass the request to a new RAN node. At 268, the new RAN node can acknowledge the request. The network can then acknowledge the SRS to the UE at 269. Finally, at 275, the UE can receive confirmation from the network. Thus, user equipment can be configured to request allocation of resources corresponding to the sounding reference signal index from a radio access network node. The process of allocation can include coordination between current and past radio access network nodes of the user equipment

For example, in an embodiment that can be viewed as an explicit SRS reconfiguration request, the LMF can send the SRS index x2 to the inactive UE in an LPP message.

The UE can request SRS x2 from the network via UL SDT. As the inactive UE may still camp on the past gNB, the request can be forwarded from the past gNB to a new gNB, namely gNB X, via the X2 interface. The new gNB, gNB X, can acknowledge the new SRS configuration to past gNB. Then, the network can acknowledge SRS x2 to the UE.

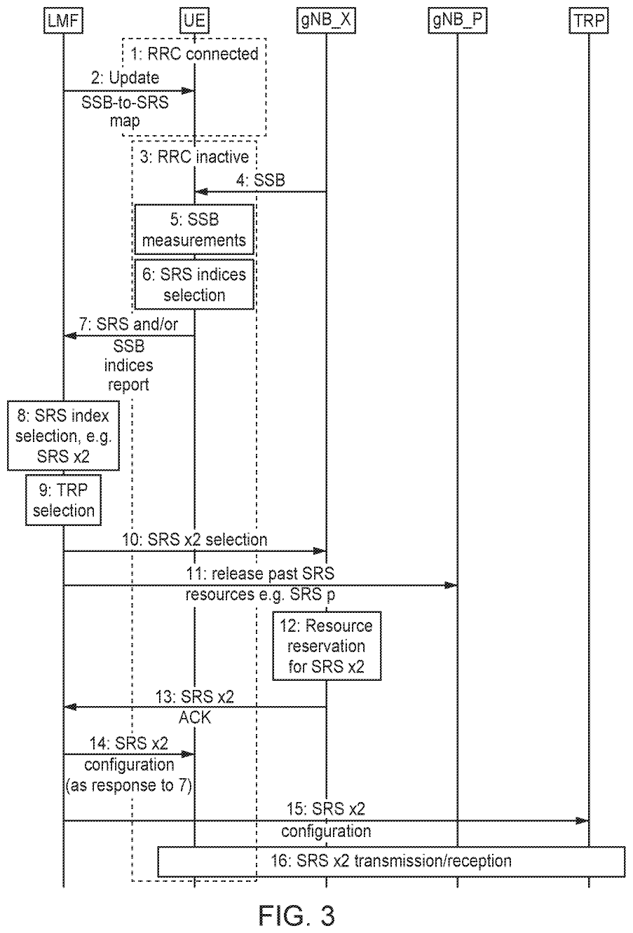

FIG. 3 illustrates a signal flow of an embodiment corresponding to an example implementation of FIG. 1. The embodiment shown in FIG. 3 can be viewed as having an implicit SRS re-configuration request and agreement.

At 1, the UE may be in RRC connected state. At 2, the LMF can update the SSB-to-SRS mapping. This may be done periodically, and the mapping may be generated by the LMF, as described above. The updating can, in other options, be performed in response to a predetermined event, or on-demand. The message at 2 may be transferred via RRC inactive UL/DL SDT.

At 3, which may be at some later time, the UE may enter RRC inactive state. At 4, a nearby RAN node, gNB_X may transmit SSB to the UE. At 5, the UE may take SSB measurements of the SSB provided by the gNB_X. If triggered by there being a new best SSB, at 6 the UE may make an SRS indices selection. The UE can, at 7, report the SSB and/or SSB indices. The message at 7 may be transferred via RRC inactive UL/DL SDT.

Then, at 8, the LMF can select an SRS index, for example SRS x2, as shown in FIG. 3. The signal flow to 8 may correspond to the processes illustrated in FIGS. 1 and 2 to 140. At 9, the LMF can make a TRP selection, for example, a selection of gNB_X over gNB_P, which may have been a past RAN node of the UE.

At 10, the LMF can indicate SRS x2 selection to gNB_X, which may be the new RAN node for the UE. Likewise, at 11, the LMF can indicate to the past gnB, gNB_P, to release past SRS resources, for example SRS having index p.

At 12, gNB_X can perform resource reservation for SRS x2. At 13, gNB_X can acknowledge SRS x2 to LMF. The procedure at 13 may ensure that the LMF obtains acknowledgement that SRS configuration has changed. The LMF may benefit from being updated about what SRS is transmitted, since the LMF can then update all neighboring TRPs about the latest SRS updates. All neighboring TRPs can be informed accordingly at 15, otherwise the neighboring TRPs may not be aware where to expect SRS from UE and thus report to LMF. At 14, the LMF can configure SRS x2 to the UE, so that the SRS x2 configuration can be provided to UE via the LMF. At 16, there can SRS transmission and reception on SRS with index x2.

In an embodiment with explicit SRS reconfiguration request, such as the embodiment illustrated in FIG. 2, a similar signal flow can be provided up to procedure 8 in FIG. 3. After that procedure, the SRS reconfiguration requests can be handled by the UE via interaction with the gNB. Specifically, after procedure 8 of FIG. 3, the following signaling may be applied. The LMF can send the SRS index x2 to the inactive UE in an LPP message. The UE can request SRS x2 from the network via UL SDT.

In a first option, as the inactive UE still camps on a past gNB, the request can go from UE to the past gNB P in an UL message. Next, the message can be forwarded from the past gNB P to gNB X via an X2 interface, using X2-backhaul signaling. After that, gNB X can acknowledge the new SRS configuration to past gNB P. Lastly, the network, for example past gNB Pm can acknowledges SRS x2 to the UE in DL SDT.

In a second option, because the SDT standard may allow for the UE to send UL SDT to gNB X directly, then an alternative may be for the request to go from the UE to gNB X in a non-serving UL SDT message. The request can then be forwarded to past gNB P from gNB X via X2 interface using X2-backhaul signaling. After that, gNB P can acknowledge the new SRS configuration to gNB X. Lastly, the network, either past gNB P or gNB X, can acknowledge SRS x2 to UE, and gNB X can reserve SRS x2, while gNB P can release past SRS configuration.

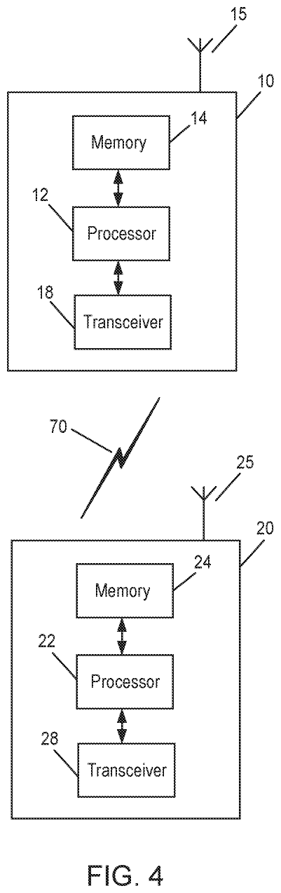

FIG. 4 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 4.

As illustrated in the example of FIG. 4, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 4, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-3, or any other method described herein. In some embodiments, as discussed herein, apparatus 10 may be configured to perform a procedure relating to providing dynamic uplink optimization procedures for positioning of inactive devices, such as reduced capability devices and other user equipment, for example.

FIG. 4 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 4.

As illustrated in the example of FIG. 4, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 4, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDM symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-3, or any other method described herein. For example, in an embodiment, apparatus 20 may be controlled to perform a process relating to providing dynamic uplink optimization procedures for positioning of inactive devices, such as reduced capability devices and other user equipment, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, in certain embodiments there may be no need to transit inactive UEs to connected state to update their SRS configuration. Certain embodiments may minimize user equipment—network bidirectional signaling, particularly in scenarios with mobility with multiple inactive UEs. Certain embodiments may be attractive for positioning low power UEs, such as RedCap UEs. Thus, certain embodiments may be highly relevant to release 18 positioning.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

LMF location management function
UE user equipment
TRP transmit receive point
LPP LTE positioning protocol
IE information element
SDT small data transmission
SRS sounding reference signal
DMRS demodulated reference signal
SSB synchronization signal block

1. An apparatus, comprising:
at least one processor; and
at least one memory including computer program code,
wherein the at least one memory and the computer program code are configured to, with the at least one processor, cause the apparatus at least to perform
transmitting to a user equipment a positioning-specific association between a sounding reference signal index and an index of downlink resources;
configuring the user equipment with a reporting behavior for uplink positioning in radio resource control inactive mode; and
receiving a parameter from the user equipment according to the configured reporting behavior.

2. The apparatus of claim 1, wherein the transmitting is performed periodically based on periodic generation of the positioning-specific association, is performed in response to a predetermined event, or is performed on demand.

3. The apparatus of claim 1, wherein the transmitting to the user equipment is contingent on the user equipment being in radio resource control connected mode.

4. The apparatus of claim 1, wherein the association is between the sounding reference signal index and a synchronization signal block index or a beam index.

5. The apparatus of claim 1, wherein the reporting behavior configuration identifies that when a predetermined trigger occurs the user equipment transmits at least one of a predetermined rank-ordered resource index values and a time stamp of the predetermined trigger, wherein the parameter comprises predetermined rank-ordered resource index values.

6. The apparatus of claim 5, wherein the predetermined trigger comprises a determination that a resource index is preferable to a previously best resource index based on criteria provided to the user equipment.

7-9. (canceled)

10. The apparatus of claim 1, wherein the receiving the parameter comprises receiving the parameter sent by the user equipment using small data transmission.

11. The apparatus of claim 1, wherein the at least one memory and the computer program code are configured to, with the at least one processor, cause the apparatus at least to perform
selecting a sounding reference signal index based on the parameter received from the user equipment.

12-16. (canceled)

17. The apparatus of claim 1, wherein the configuring is performed while the user equipment is in radio resource control inactive mode without the user equipment switching to radio resource control connected mode.

18. The apparatus of claim 1, wherein a single message comprises a first information element comprising the positioning-specific association and a second information element comprising the configuration of the report behavior.

19. An apparatus, comprising:
at least one processor; and
at least one memory including computer program code,
wherein the at least one memory and the computer program code are configured to, with the at least one processor, cause the apparatus at least to perform
receiving a positioning-specific association between a sounding reference signal index and an index of downlink resources;
receiving a configuration of a reporting behavior for uplink positioning in radio resource control inactive mode; and
transmitting a parameter according to the configured reporting behavior.

20. The apparatus of claim 19, wherein the receiving the positioning-specific association is performed in radio resource control connected mode.

21. The apparatus of claim 19, wherein the association is between the sounding reference signal index and a synchronization signal block index or a beam index.

22. The apparatus of claim 19, wherein the reporting behavior configuration identifies that when a predetermined trigger occurs the apparatus is caused to transmit at least one of predetermined rank-ordered resource index values or a time stamp of the predetermined trigger.

23. The apparatus of claim 22, wherein the predetermined trigger comprises a determination that a resource index is preferable to a previously best resource index based on criteria used by the apparatus.

24. The apparatus of claim 22, wherein the rank-ordered resource index values comprise a first predetermined number of values ordered by the criteria used by the apparatus.

25. The apparatus of claim 23, wherein the criteria is based on at least one of synchronization signal block reference signal received power, synchronization signal block signal to interference plus noise ratio, synchronization signal block line of sight indication, or synchronization signal block timing advance.

26. The apparatus of claim 23, wherein the rank-ordered resource index values comprise a second predetermined number of sounding reference signal indices, wherein the sounding reference signal indices are derived from the positioning-specific association.

27. The apparatus of claim 19, wherein the transmitting the parameter comprises transmitting the parameter using small data transmission.

28-45. (canceled)

46. A method, comprising:
receiving, by a user equipment, a positioning-specific association between a sounding reference signal index and an index of downlink resources;
receiving, by the user equipment, a configuration of a reporting behavior for uplink positioning in radio resource control inactive mode; and
transmitting, by the user equipment, a parameter according to the configured reporting behavior.

47-83. (canceled)
